(19) United States
(12) Patent Application Publication
(10) Pub. No.: US 2025/0201964 A1
(43) Pub. Date: Jun. 19, 2025

(54) HEAT EXCHANGE ASSEMBLY

(71) Applicant: Rimac Technology LLC, Sveta Nedelja (HR)

(72) Inventors: Niko Milanovic, Nasice (HR); Alan Leigh Walchester, Warwick (GB); Andriy Ponomar, Zagreb (HR)

(21) Appl. No.: 18/926,686

(22) Filed: Oct. 25, 2024

(30) Foreign Application Priority Data
Dec. 14, 2023 (EP) 23216652.0

(51) Int. Cl. H01M 10/656; H01M 10/613

(52) U.S. Cl. CPC H01M 10/656; H01M 10/613

(57) ABSTRACT

A heat exchange assembly for a battery system is provided. A heat exchange element extends along a first direction with at least one first channel and at least one second channel provided between the first and second surfaces, each extending along the first direction. At least one first opening is provided on the first surface, and at least one second opening is provided on the second surface. A fluid distribution member is mounted on the heat exchange element, comprising an inlet port for distributing fluid and an outlet port for distributing fluid out.

### CROSS-REFERENCE

This application claims priority to European Patent Application No. 23216652.0, filed Dec. 14, 2023, the entire disclosure of which is incorporated herein by reference.

### TECHNICAL FIELD

The present invention relates to the field of battery systems comprising a plurality of battery cells and more particularly to the field of heat exchange in battery systems.

### BACKGROUND

Batteries comprising a plurality of battery cells are playing an increasing role in energy storage for both mobility and grid storage applications.

The temperature of the battery cells is critical for the performance of the battery cells, for example for the charge and discharge capacity of the battery cells. The temperature of the battery cells affects also the lifetime of the battery cells and accordingly the lifetime of the battery.

During operation, the battery cells produce heat which needs to be properly rejected from the battery in order that a safe operation of the battery is ensured.

Further, heating of the battery cells may be required in situations in which the temperature of the battery, influenced, for example, by the temperature of the surrounding environment of the battery, is disadvantageous for the operation of the battery. In such situations, it may be required that the battery is heated, at least up to a predetermined temperature, above which safe operation of the battery can be guaranteed before the battery is operated.

For this, the battery is normally equipped with a system for heat exchange transfer. A system for heat exchange transfer normally employs a heat exchange fluid for heat exchange between the battery cells and the heat exchange fluid.

The temperature of the heat exchange fluid normally changes as the heat exchange fluid flows through the heat exchange system. For cooling, the temperature of the heat exchange fluid normally increases since the battery cells give away heat to the heat exchange fluid. For heating, the temperature of the heat exchange fluid normally decreases since the heat exchange fluid gives away heat to the battery cells. This change of temperature of the heat exchange fluid leads to some battery cells exhibiting higher degree of heat exchange than other of the battery cells in the battery.

Accordingly, there is a need for a heat exchange system capable of maintaining a more uniform temperature of the heat exchange fluid.

### SUMMARY

To achieve this object in one aspect the present invention provides a heat exchange assembly for a battery system, the battery system comprising a plurality of battery cells, the heat exchange assembly comprising:
a heat exchange element extending along a first direction and having:
   a first surface and a second surface facing the first surface along a second direction perpendicular to the first direction;
   at least one first channel and at least one second channel each for accommodating a fluid and provided between the first surface and the second surface, each of the at least one first channel and the at least one second channel extending along the first direction,
and
   at least one first opening provided on the first surface, the at least one first opening being in a fluid communication with the at least one first channel, and at least one second opening provided on the second surface, the at least one second opening being in a fluid communication with the at least one second channel,
the heat exchange assembly comprising further:
a fluid distribution member mounted on the heat exchange element, the fluid distribution member comprising an inlet port for distributing a fluid in the at least one first channel via the first opening and an outlet port for distributing a fluid out of the at least one second channel via the second opening.

### BRIEF DESCRIPTION OF THE DRAWINGS

Embodiments of the present invention which are presented for better understanding the inventive concept of the present invention, but which are not to be seen as limiting the present invention, will now be described with reference to the figures in which:

FIG. 1 shows schematically a heat exchange assembly;

FIG. 2a shows schematically a heat exchange assembly according to an embodiment of the present invention;

FIG. 2b shows a cross-section of a heat exchange element of the heat exchange assembly according to an embodiment of the present invention;

FIG. 3a shows the heat exchange element of the heat exchange assembly according to an embodiment of the present invention;

FIG. 3b shows the heat exchange assembly according to an embodiment of the present invention;

FIG. 4 shows the elements of the fluid distribution member of the heat exchange assembly according to an embodiment of the present invention;

FIG. 5 shows the elements of the heat exchange assembly according to an embodiment of the present invention;

FIG. 6 shows a cross-section of a part of the heat exchange assembly according to an embodiment of the present invention;

FIG. 7 shows a cross-section of a part of the heat exchange assembly according to an embodiment of the present invention;

FIG. 8 shows the heat exchange element of the heat exchange assembly according to an embodiment of the present invention;

FIGS. 9a-9d shows examples of end member of the heat exchange assembly in embodiments of the present invention;

FIG. 10a shows a distribution of the first openings and the second openings on the heat exchange element of the heat exchange assembly according to an embodiment of the present invention;

FIG. 10b shows a distribution of the first openings on the heat exchange assembly according to an embodiment of the present invention;

FIGS. 11a and 11b show examples of the fluid distribution member of the heat exchange assembly in embodiments of the present invention;

FIGS. 12a and 12b show the heat exchange assembly according to embodiments of the present invention;

FIG. 13 shows elements of the heat exchange assembly according to an embodiment of the present invention;

FIG. 14 shows a cross-sectional view of the fluid distribution member of the heat exchange assembly according to an embodiment of the present invention;

FIG. 15 shows a heat exchange assembly according to an embodiment of the present invention;

FIG. 16 shows a heat exchange assembly according to an embodiment of the present invention;

### DETAILED DESCRIPTION

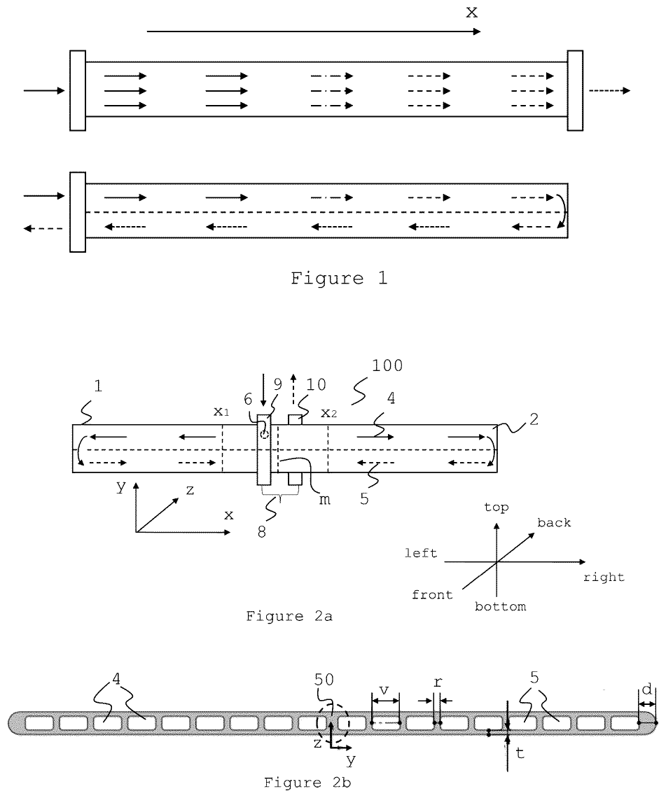

There is shown in the upper panel in FIG. 1 schematically a heat exchange assembly comprising a heat exchange element extending along a first direction (denoted with x in the figure). The heat exchange element may be used in a battery system comprising a plurality of battery cells. The heat exchange element may have a shape of a parallelepiped with a front surface (the surface shown in FIG. 1) and a back surface facing the front surface. In the heat exchange element one or more channels are provided between the front surface and the back surface. A heat exchange fluid is allowed to flow through the one or more channels. The plurality of channels are schematically represented in FIG. 1 with arrows. The heat exchange element further comprises an inlet port for distributing the heat exchange fluid in the one or more channels and an outlet port for distributing the heat exchange fluid outside of the one or more channels and hence outside of the heat exchange element.

There is shown in the upper panel in FIG. 1 that the inlet port and the outlet port are arranged at two end surfaces of the heat exchange element, the two end surfaces facing each other along the first direction. There is shown in the upper panel in FIG. 1 that the inlet port is arranged at the end surface on the left of the figure (left end surface), while the outlet port is arranged at the end surface on the right of the figure (right end surface). With such arrangement of the inlet port and the outlet port the heat exchange fluid flows from the left end surface toward the right end surface.

With such arrangement of the inlet port and the outlet port, the temperature of the heat exchange fluid changes (this is schematically represented in FIG. 1 with the arrows being presented with a solid line, a dashed dotted line and a dashed line) as the fluid flows toward the outlet port arranged at the right end surface. In other words, with such arrangement of the inlet port and the outlet port, in the middle portion of the heat exchange element the temperature of the heat exchange fluid (dashed dotted line arrow) is different from the temperature of the heat exchange fluid in the portion closer to the left end surface (solid line arrow). In the portion of the heat exchange element closer to the right end surface the temperature of the heat exchange fluid (dashed line arrow) is even more different from the temperature of the heat exchange fluid in the portion closer to the left end surface.

There is shown in the lower panel in FIG. 1 schematically a heat exchange element on which the inlet port and the outlet port are arranged at the same end surface, here the left end surface. In this arrangement of the inlet port and the outlet port, the heat exchange clement comprises at least one channel arranged in the upper part of the heat exchange clement (upper part is above the dashed line in FIG. 1) and at least one channel in the lower part of the heat exchange clement (lower part is below the dashed line in FIG. 1). The at least one channel arranged in the upper part and the at least one channel arranged in the lower part are in a fluid communication in the vicinity of the right end surface. The heat exchange fluid enters the at least one channel arranged in the upper part via the inlet port and flows toward the right end surface. In the vicinity of the right end surface the heat exchange fluid makes a U-turn and enters the at least one fluid channel arranged in the lower part and flows toward the outlet port arranged at left end surface. The heat exchange fluid leaves the heat exchange element via the outlet port. In this arrangement of the inlet port and the outlet port, the temperature of the heat exchange fluid changes (this is schematically represented in FIG. 1 with the arrows being presented with a solid line, a dashed dotted line and a dashed line) as it flows toward the outlet port.

Hence, in a heat exchange element as the one shown in the upper panel in FIG. 1 and as the one shown in the lower panel in FIG. 1 it is difficult to maintain uniform the temperature of the heat exchange fluid between the inlet port and the outlet port. Since the temperature of the heat exchange fluid is not uniform, some battery cells will exhibit a higher degree of heat transfer than other of the battery cells.

To account for this, the present invention proposes a heat exchange assembly that provides for better flow distribution of the heat exchange fluid in terms of thermal performance.

FIG. 2a shows schematically a heat exchange assembly 100 according to an embodiment of the present invention. The heat exchange assembly 100 is for a battery system. The battery system comprises a plurality of battery cells. The battery cells may be mounted on the heat exchange assembly 100 or may be in direct or indirect contact with the heat exchange assembly 100 without being fixed on the heat exchange assembly 100. The battery system may be a battery module or a battery pack. The battery pack may comprise one or more battery modules. In other embodiments of the present invention, the battery pack may comprise groups of battery cells. The battery cell in each group may be mounted on the heat exchange assembly 100 or may be in direct or indirect contact with the heat exchange assembly 100 without being fixed to the heat exchange assembly.

The heat exchange assembly 100 comprises a heat exchange element 1. The heat exchange element 1 may have a form of a parallelepiped. The surfaces may be flat surfaces, however this is not limiting, as elaborated further below. In other words, at least one or more surfaces may not be flat surfaces. The heat exchange element 1 extends along a first direction. In FIG. 2a the first direction is denoted as x. The size of the heat exchange element 1 along the first direction is referred here below also as the length of the heat exchange element 1.

The heat exchange clement 1 has a first surface 2. The first surface 2 is shown in FIG. 2a. This surface may also be called front surface. The heat exchange element 1 further has a second surface (not shown in FIG. 2a) facing the first surface 2 along a second direction perpendicular to the first direction. The direction along which the second surface is facing the first surface is denoted with z in FIG. 2a. The size of the heat exchange clement 1 between the first surface 2 and the second surface is referred here below also as the thickness of the heat exchange element 1.

The heat exchange element 1 comprises further at least one first channel 4 (schematically represented with arrows) and at least one second channel 5 (schematically represented with arrows), each for accommodating a fluid and provided between the first surface 2 and the second surface. The fluid may also be called a heat exchange fluid here below. Each of the at least one first channel 4 and the at least one second channel 5 extends along the first direction (x direction).

As elaborated further below, the at least one first channel 4 and the at least one second channel 5 may be in fluid communication with each other. There is shown in FIG. 2a that the at least one first channel 4 and the at least one second channel 5 may be in fluid communication with each other at each of the end sides of the heat exchange element 1. The end sides are the end sides facing each other along the x direction. They may also be called here below left end side and right end side (end side on the left in FIG. 2a and end side on the right in FIG. 2a).

The heat exchange element 1 comprises further at least one first opening 6 provided on the first surface 2. The at least one first opening 6 is in a fluid communication with the at least one first channel 4. The heat exchange element 1 comprises further at least one second opening (not shown in FIG. 2a) provided on the second surface 3. The at least one second opening is in a fluid communication with the at least one second channel 5.

Each of the at least one first opening 6 and at least one second opening 7 being in a fluid communication with the respective one of the at least one first channel 4 and at least one second channel 5 means that the fluid can enter or exit the respective one of the at least one first channel 4 and at least one second channel 5 via the respective one of the at least one first opening 6 and at least one second opening 7.

The heat exchange assembly 100 comprises further a fluid distribution member 8 mounted on the heat exchange element 1. The fluid distribution member 8 comprises an inlet port 9 for distributing the fluid in the at least one first channel 4 via the at least one first opening 6 and an outlet port 10 for distributing the fluid out of the at least one second channel 5 via the at least one second opening 7.

The at least one first channel 4 and the at least one second channel 5 may be arranged along a third direction that is perpendicular to each one of the first direction (x direction) and the second direction (z direction). In FIG. 2a, the third direction is denoted with y. The size of the heat exchange element 1 along the y direction is also called here below the height of the heat exchange element 1. The at least one first channel 4 and the at least one second channel 5 may be arranged to face each other along the third direction.

Preferably, the at least one first channel 4 is arranged in the top part of the heat exchange element 1 (upper side in the figure) and the at least one second channel 5 is arranged in the bottom part of the heat exchange element 1 (lower side in the figure). In other words, preferably, the heat exchange assembly 100 is arranged in the battery system such that the at least one first channel 4 is above the at least one second channel 5.

The at least one first opening 6 and the at least one second opening 7 may be arranged along the third direction (y direction). The at least one first opening 6 and the at least one second opening 7 may be provided on the first surface 2 and the second surface 3 respectively in the middle portion of the heat exchange element 1.

There is shown in FIG. 2a that the at least one first opening 6 and the at least one second opening 7 are provided on the first surface 2 and the second surface 3 respectively in the middle portion of the heat exchange element 1.

The fluid distribution member 8 may be mounted on the heat exchange element 1 in a portion of the heat exchange element 1 where the respective one of the at least one first opening 6 and at least one second opening 7 is provided. There is shown in FIG. 2a that the fluid distribution member 8 is mounted on the heat exchange element 1 in the middle portion of the heat exchange clement 1.

The middle portion of the heat exchange element 1 may be a portion of the heat exchange element 1 that may comprise the central line m of the heat exchange element 1 but may also be a portion of the heat exchange element 1 on one side or the other side of the central line along the direction of extension of the heat exchange element 1. Preferably, in an embodiment of the present invention, the middle portion is a portion of the heat exchange element 1 that comprises the central line m and extends on both sides (along the first direction) of the central line m to a predetermined position x1 and a predetermined position x2. The term “central line” m denotes the line extending in a direction perpendicular to the direction of extension of the heat exchange clement (this direction being denoted as y direction in FIG. 2a) and symbolically cutting the heat exchange element 1 and hence symbolically dividing the heat exchange element 1 at two equal parts (left part and right part in FIG. 2a). In other words, since the heat exchange element 1 is elongated along the x direction, the central line m is the line that divides the heat exchange clement 1 at two equal halves along its length. Therefore, preferably, in an embodiment of the present invention, the central line symbolically divides the middle portion of the heat exchange element 1 into two, preferably equal, sub-portions.

The fluid distribution member 8 does not need to be mounted on the heat exchange clement 1 in the middle portion of the heat exchange element 1. In addition, the at least one first opening 6 and at least one second opening 7 do not need to be provided in the middle portion of the heat exchange element 1. For example, in embodiments of the present invention, the fluid distribution member 8 may be mounted in a portion of the heat exchange element 1 closer to the left end side or the right end side of the heat exchange element 1. In addition, the at least one first opening 6 and at least one second opening 7 may be provided in a portion of the heat exchange element 1 closer to the left end side or the right end side of the heat exchange element.

In embodiments of the present invention, it is however preferable that the fluid distribution member 8 is mounted in the middle portion of the heat exchange element 1. In embodiments of the present invention, it is however preferable that the at least one first opening 6 and at least one second openings 7 are provided in the middle portion of the heat exchange element 1.

The heat exchange assembly 100 according to the embodiment of the present invention shown in FIG. 2a enables better flow distribution of the heat exchange fluid in terms of thermal performance in comparison to the arrangements shown in FIG. 1. The battery cells that may be mounted on the heat exchange assembly 100, for example on the first surface 2 and/or on the second surface 3 of the heat exchange element 1 or may be in a direct or indirect contact with the heat exchange assembly 100 without being fixed to the heat exchange assembly 100 may be more evenly cooled since the temperature of the heat exchange fluid closer to the left end side end and the right end side end of the heat exchange element 1 is more uniform. The arrangement in which the heat exchange fluid makes a U-turn in the vicinity of the left end side and the vicinity of the right end side (double U-turn) ensures that the battery cells receive a more uniform heat exchange effect from the heat exchange fluid. In addition, the heat exchange fluid has a shorter path to exchange heat which is increasing the heat exchange efficiency.

The profile of the heat exchange element 1 can vary in terms of thickness t, thickness between the at least one first channel 4 and the at least one second channel 5 (also called rib thickness r), cross-section of each of the at least one first channel 4 and at least one second channel 5 (also called void size v) as well as the number of first channels 4 and the number of second channels 5. This profile of the heat exchange element 1 affects the thermal performance of the heat exchange element 1, the pressure drop and the structural rigidity of the heat exchange element 1. Therefore, the profile of the heat exchange element 1 is normally chosen in dependence of the application environment of the heat exchange element 1. The profile of the heat exchange clement 1 is normally chosen to balance between thermal performance, pressure drop and structural rigidity.

There is shown in FIG. 2b a cross section of a heat exchange element 1 comprising a plurality of first channels 4 and a plurality of second channels 5 in an embodiment of the present invention is shown. Typical dimensions are for example 3.68 mm for v, 0.80 mm for r, 2.25mm for d and 0.60 mm for t.

The central rib 50 is the divider rib between the at least one first channel 4 and the at least one second channel 5, in this embodiment the divider rib between the plurality of first channels 4 and the plurality of second channels 5. The thickness of the central rib 50 can be different from the thickness of the other ribs. The thickness of the central rib 50 may be adjusted to prevent or reduce as much as possible the heat transfer between the at least one first channel 4 and the at least one second channel 5. More specifically, the thickness of the central rib 50 may be adjusted to prevent or reduce as much as possible the heat transfer between the neighbouring first channel 4 and second channel 5. The thickness of the central rib 50 may be larger than the thickness of the other ribs. In this case, less heat is exchanged between the neighbouring first channel 4 and second channel 5.

In one or more embodiments of the present invention the heat exchange element 1 may be a one-piece extruded element. It is to be therefore understood that the heat exchange element 1 may be formed by extrusion as a one-piece element or a one-piece component. The word “component” may be used interchangeably with the word “element” herein. A one-piece clement or a one-piece component is to be understood as a single physically undivided piece. In other words, for manufacturing the heat exchange element 1, a piece of material may be shaped by extrusion for forming the first surface 2, the second surface 3, the at least one first channel 4 and the at least one second channel 5. Afterwards, the at least one first opening 6 and the at least one second opening 7 may be formed by drilling on the respective one of the first surface 2 and the second surface 3.

Since the at least one first opening 6 and the at least one second opening 7 are provided on the heat exchange element 1 on the respective one of the first surface 2 and the second surface 3 it is possible to provide the heat exchange element 1 as a one-piece extruded element. This eliminates the need for providing the heat exchange element 2 in at least two pieces and joining them in the portion where the fluid distribution member 8 is mounted. The one-piece heat exchange element 1 has increased structural stability over a heat exchange element 1 provided in two or more pieces.

In embodiments of the present invention the at least one first opening 6 and the at least one second opening 7 may be arranged along the central line m on the respective one of the first surface 2 and the second surface 3. In other embodiments of the present invention, the at least one first opening 6 may be arranged on one side of the central line m and/or the at least one second opening 7 may be provided on the opposite side of the central line m. In other words, in these embodiments of the present invention the at least one first opening 6 and the at least one second opening 7 may be arranged on opposite sides of the central line m. In still other embodiments of the present invention, the at least one first opening 6 and the at least one second opening 7 may be provided on the same side of the central line m.

In embodiments of the present invention the at least one first opening 6 and the at least one second opening 7 may have the same shape and/or the same size. For example, the at least one first opening 6 and the at least one second opening 7 may have a circular shape.

In other embodiments of the present invention the shape of the at least one first opening 6 may be different than the shape of the at least one second opening 7 and/or the size of the at least one first opening 6 may be different than the size of the at least one second opening 7.

As elaborated above, in an embodiment of the present invention, the fluid distribution member 8 may be mounted on the heat exchange element 1 in the middle portion of the heat exchange clement 1. The fluid distribution member 8 may be mounted on the heat exchange element 1 such that the inlet port 9 is arranged to face the first surface 2 and the outlet port 10 is arranged to face the second surface 3.

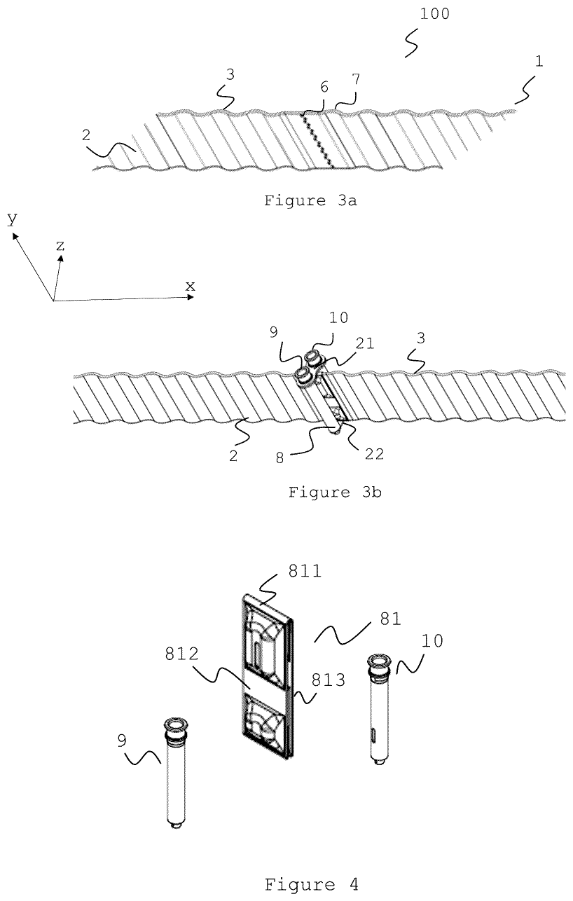

There is shown in FIG. 3a a part of the heat exchange element 1 in an embodiment of the present invention. In this embodiment, the heat exchange element 1 has a plurality of first openings 6 provided on the first surface 2 and a plurality of second openings 7 provided on the second surface 3.

Further, there is shown in FIG. 3a that the first surface 2 and the second surface 3 are not flat surfaces but have formed undulations. Each undulation may be arranged to accommodate at least one battery cell. In other words, in each undulation on the first surface 2 a battery cell may be arranged. The battery cell may be arranged in the undulation by way of gluing it on the first surface 2 in the corresponding undulation. However, gluing may not be necessary and other manners of providing the battery cell in the undulation may also be used. Similarly, in each undulation on the second surface 3 a battery cell may be arranged.

The undulations increase the packing density of the battery cells and increase the compactness of the battery system. Preferably, the undulations are provided in portions of the heat exchange element 1 other than the middle portion in embodiments of the present invention in which the fluid distribution member 8 is mounted in the middle portion of the heat exchange element 1. In other words, the undulations are preferably provided in portions of the heat exchange element 1 other than the portion where the fluid distribution member 8 is mounted. In other embodiments, it is also possible to provide undulations in the portion of the heat exchange clement 1 where the fluid distribution member 8 is mounted on the heat exchange element 1.

There is shown in FIG. 3b the fluid distribution member 8 mounted on the heat exchange clement 1 in an embodiment of the present invention. There is shown in FIG. 3b that the fluid distribution member 8 is mounted on the heat exchange element 1 such that the inlet port 9 is arranged to face the first surface 2 and the outlet port 10 is arranged to face the second surface 3.

Preferably, in one or more embodiments of the present invention, the fluid distribution member 8 is a pre-formed one-piece element (pre-formed one-piece component) arranged to be mounted on the heat exchange element 1 by sliding along the third direction (y direction).

In one or more embodiments of the present invention, as shown in FIG. 4 the fluid distribution member 8 may have a fluid distribution member plate 81 on which the inlet port 9 and the outlet port 10 are arranged. The fluid distribution member plate 81 may be a bent plate having a bent portion 811 and two sides 812, 813 facing each other, with a distance between the two sides arranged to fit on the heat exchange element 1 on the first surface 2 and the second surface 3. The fluid distribution member 8 is arranged to be mounted on the heat exchange element 1 by sliding it along the third direction (y direction) such that the one side 812 slides on the first surface 2 and the other side 813 slides on the second surface 3. It is to be understood that although the elements are shown in FIG. 4 as separate elements, preferably, the fluid distribution member 8 is a pre-formed one-piece element. In other words, the elements shown in FIG. 4 may be joined together by brazing, thereby forming the fluid distribution member 8 as a one-piece element to be mounted on the heat exchange element 1.

The heat exchange assembly 100 may comprise further a first support element 21 in an embodiment of the present invention. In addition, or alternatively, the heat exchange assembly 100 may comprise a second support element 22. The first support element 21, and the second support element 22 may be each mounted on the fluid distribution member 8. The first support clement 21 may comprise an inlet opening 211 for accommodating the inlet port 9 and an outlet opening 212 for accommodating the outlet port 10 of the fluid distribution member 8. Similarly, the second support element 22 may comprise an inlet opening 221 for accommodating the inlet port 9 and an outlet opening 222 for accommodating the outlet port 10 of the fluid distribution member 8.

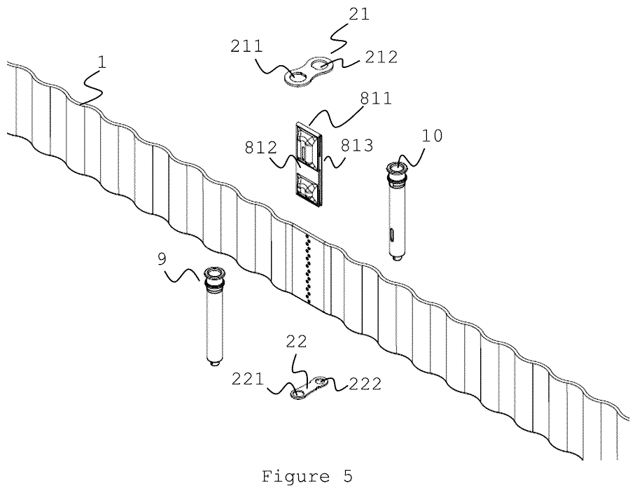

There is shown in FIG. 5 schematically an exploded view of the heat exchange element 1, the fluid distribution member 8, the first support plate 21 and the second support plate 22 in an embodiment of the present invention. The fluid distribution member 8 may be mounted on the heat exchange element 1 by way of sliding as elaborated above.

In one or more embodiments of the present invention, the inlet port 9, the outlet port 10 and the first support element 21 may be assembled together. In a further step, the fluid distribution member 81 may be mounted along the y direction around the heat exchange member 1. In a still further step, the assembled inlet port 9, the outlet port 10 and the first support element 21 may be positioned on the fluid distribution member 81. Subsequently, the second support element 22 may be mounted to connect the inlet port 9 and the outlet port 10. In a still further step, a brazing may be performed.

The first support plate 21 and the second support plate 22 facilitate the aligning of the fluid distribution member 8 on the heat exchange element 1 and increase the structural stability of the heat exchange assembly 100.

FIG. 3b shows the fluid distribution member 8 mounted on the heat exchange element 1, with the first support plate 21 and the second support plate 22 mounted on the respective side.

The inlet port 9 may comprise at least one inlet opening 91 arranged to be in fluid communication with the at least one first opening 6 and the outlet port 10 may comprise at least one outlet opening 101 arranged to be in a fluid communication with the at least one second opening 7.

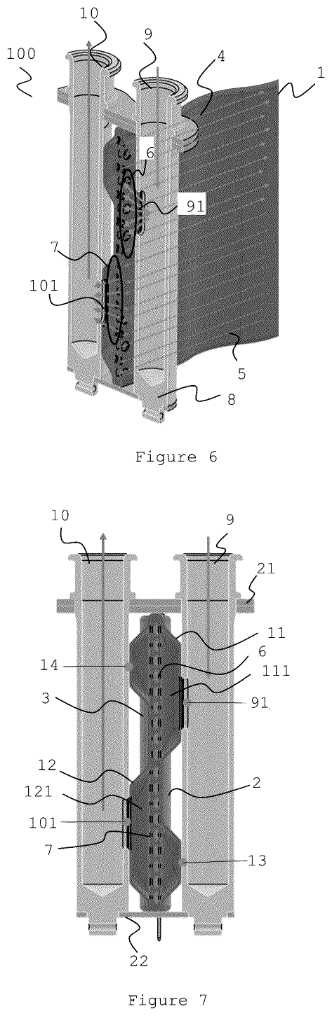

There is shown in FIG. 6 a cross-sectional view of the heat exchange assembly 100 in an embodiment of the present invention. There is shown in FIG. 6 that the inlet port 9 of the fluid distribution member 8 comprises one inlet opening 91 and the outlet port 10 of the fluid distribution member 8 comprises one outlet opening 101. In the embodiment shown in FIG. 6 the heat exchange element 1 comprises a plurality of first openings 6 and a plurality of second openings 7. The one inlet opening 91 is in fluid communication with the plurality of first openings 6 and the one outlet opening 101 is in fluid communication with the plurality of second openings 7 (the fluid communication is schematically represented with arrows).

In other embodiments of the present invention, the inlet port 9 may comprise a plurality of inlet openings 91 and the outlet port 10 may comprise a plurality of outlet openings 101. The plurality of inlet openings 91 may be arranged to be in a fluid communication with the at least one opening 6 and the plurality of outlet openings 101 may be arranged to be in a fluid communication with the at least one second opening 7. Providing a plurality of inlet openings 91 and a plurality of outlet openings 101 increases the structural stability of the fluid distribution member 8 but it also increases the pressure drop on the heat exchange element 1. On the other hand, one inlet opening 91 and one outlet opening 9 achieves better pressure drop on the heat exchange clement 1. Depending on the material of the heat exchange element 1 and the material of the fluid distribution member 8, as well as on the specific application of the heat exchange assembly 100 in the battery system and the specific application of the battery system, the number of inlet openings 91 and the number of outlet openings 101 may be chosen to balance between the pressure drop and the structural stability.

In one or more embodiments of the present invention, in the heat exchange element 1 in the portion where the fluid distribution member 8 is to be mounted, for example in the middle portion as elaborated above, the first surface 2 may have a first bulge 11 extending outwards from the heat exchange element 1 and the second surface 3 may have a first bulge 12 extending outwards from the heat exchange element 1. The first bulge 11 of the first surface 2 may form an inlet chamber 111 around the at least one first opening 6 and the first bulge 12 of the second surface 3 may form an outlet chamber 121 around the at least one second opening 7.

There is shown in FIG. 7 a cross-sectional view of the heat exchange assembly in an embodiment of the present invention. There is shown in FIG. 7 the first surface 2 having a first bulge 11. The first bulge 11 forms an inlet chamber 111 around the at least one first openings 6. The inlet opening 91 of the inlet port 9 opens into the inlet chamber 111. There is shown in FIG. 7 the second surface 3 having a first bulge 12. The first bulge 12 forms an outlet chamber 121 around the at least one second openings 7. The outlet opening 101 opens into the outlet chamber 121.

There is further shown in FIG. 7 that the first surface 2 has a second bulge 13 extending outwards from the heat exchange element 1. The second surface 3 has a second bulge 14 extending outwards from the heat exchange element 1. A wall of the inlet port 9 abuts against at least a part of the second bulge 13 of the first surface 2 and a wall of the outlet port 10 abuts against at least a part of the second bulge 14 of the second surface 3. Each of the second bulges 13, 14 of the respective one of the first surface 2 and second surface 3 facilitates the alignment of the fluid distribution member 8 on the heat exchange element.

Each of the first surface 2 and the second surface 3 between the respective first bulge 11, 12 and the respective second bulge 13, 14 the respective one of the first surface 2 and the second surface 3 may have a flat shape.

This form of the first surface 2 and the second surface 3 prevents the heat exchange fluid to be distributed in the at least one first channel 4 mixes with the heat exchange fluid to be distributed away from the at least one second channel 5.

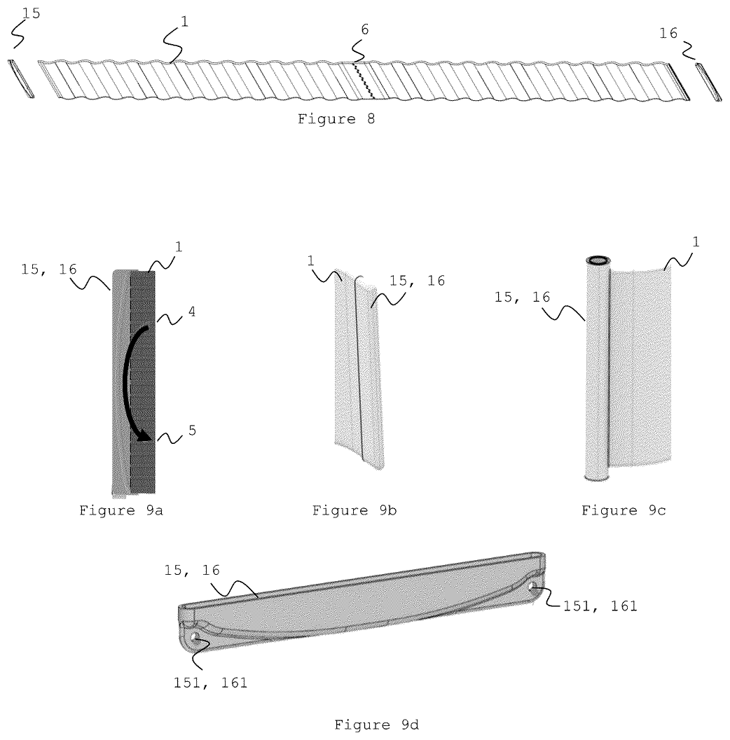

In an embodiment of the present invention, the heat exchange assembly 100 may further comprise a first end member 15 arranged on one end side of the heat exchange element 1 and a second end member 16 arranged on the other end side of the heat exchange element 1. This is shown schematically in FIG. 8. Each of the first end member 15 and the second end member 16 may be arranged to establish a fluid communication between the at least one first channel 4 and the at least one second channel 5.

In one embodiment of the present invention, for establishing a fluid communication between the at least one first channel 4 and the at least one second channel 5, each of the first end member 15 and the second end member 16 may have a curved shape for guiding the fluid between the at least one first channel 4 and the at least one second channel 5. The curved shape is shown in FIG. 9a. The curved shape gives each of the first end member 15 and second end member 16 a “banana”-like shape. There is shown in FIG. 9a with the arrow the path along which the heat exchange fluid is guided from the at least one first channel 4 to the at least one second channel 5. In each of the first end member 15 and second end member 16 no more channels are needed to be provided. The fluid is guided to flow from the at least one first channel 4 to the at least one second channel 5 through the shape of each of the first end member 15 and second end member 16, the shape being such as to naturally force the fluid to flow from the at least one first channel to the at least one second channel. For this it is preferable, as also elaborated above, that the at least one first channel 4 is provided in the top part of the heat exchange element 1 and the at least one second channel 5 is provided in the lower part of the heat exchange element 1. Therefore, each of the first end member 15 and second end member 16 may be a one-piece component respectively pushed on the respective end side surface of the heat exchange element 1 to thereby close the heat exchange element 1.

In embodiments of the present invention each of the first end member 15 and second end member 16 may have other shapes. Examples in embodiments of the present invention are shown in FIG. 9b and FIG. 9c. There is shown in FIG. 9b an example of a first end member 15 and second end member 16 with a rectangular shape. There is shown in FIG. 9c an example of a first end member 15 and a second end member 16 with a cylindrical shape.

In embodiments of the present invention each of the first end member 15 and second end member 16 may comprise at least one opening 151, 161. The at least one opening 151, 161 may be used for hanging the heat exchange element 1 during coating application for adding isolation material on the outer surface of the heat exchange element 1. FIG. 9d shows an example of first end member 15 and second end member 16 provided with two such openings 151, 161.

In one or more embodiments of the present invention, in the heat exchange element 1, a plurality of first channels 4 may be provided along the third direction and/or a plurality of second channels may be provided along the third direction. Preferably, the total number of first channels and/or second channels is a multiple of 2.

The cross-section of each of the plurality of first channels 4 may be the same or may be different from the cross-section of the other of the plurality of first channels 4 and/or from the cross-section of one or more or all of the plurality of second channels 5.

In embodiments of the present invention in which the number of first channels 4 is larger than the number of second channels 5, it may be preferable to provide one or more or all of the plurality of second channels 5 with larger cross-section than the cross-section of one or more or all of the plurality of first channels 4.

It is however preferable to provide the same number of first channels 4 and second channels 5 with the same cross-section to ensure for a uniform distribution of the fluid through the first channels 4 and the second channels 5.

In embodiments of the present invention in which a plurality of first channels 4 and/or a plurality of second channels 5 are provided one first opening 6 may be provided arranged to be in fluid communication with each of the plurality of first channels 4 and one second opening 7 may be provided arranged to be in fluid communication with each of the plurality of second channels 5.

In embodiments of the present invention in which a plurality of first channels 4 and/or a plurality of second channels 5 are provided, a plurality of first openings 6 may be provided on the first surface. Each of the plurality of first openings 6 may be in a fluid communication with one of the plurality of first channels 4. In addition, or alternatively, a plurality of second openings 7 may be provided on the second surface 3. Each of the plurality of second openings 7 may be in a fluid communication with one of the plurality of second channels 5.

In embodiments of the present invention, it is also possible that the number of first openings 6 is smaller or larger than the number of first channels 4 and the number of second openings 7 is smaller or larger than the number of second channels 5.

In an embodiment of the present invention, the number of first openings 6 may be smaller than the number of first channels 4. In this embodiment of the present invention, each one of the plurality of first openings 6 may be in a fluid communication with a group of the first channels 4. Additionally, or alternatively, the number of second openings 7 may be smaller than the number of second channels 5. Each one of the plurality of second openings 7 may be in a fluid communication with a group of the second channels 5.

In this embodiment of the present invention, a plurality of secondary first channels may be provided in the heat exchange element 1, each one of the plurality of secondary first channels establishing a fluid communication between one first opening 6 and the corresponding group of first channels 4. In addition or alternatively, a plurality of secondary second channels may be provided in the heat exchange element 1, each one of the plurality of secondary second channels establishing a fluid communication between one second opening 7 and the corresponding group of second channels 5.

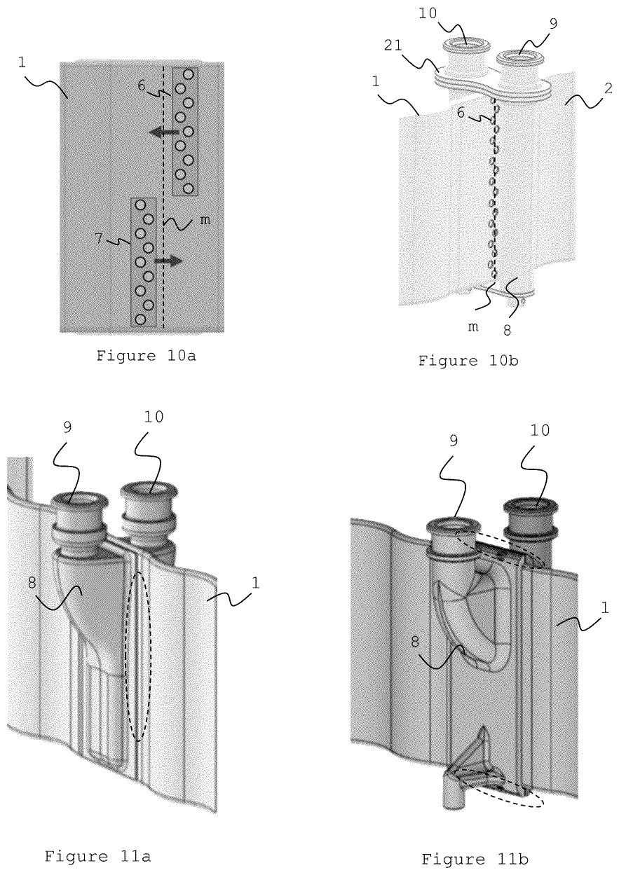

The plurality of first openings 6 and the plurality of second openings 7 may be arranged along the central line m or may be arranged on opposite sides of the central line m. In one or more embodiments of the present invention, the plurality of first openings 6 may be arranged in a zig zag pattern on one side of the central line and the plurality of second openings may be arranged in a zig zag pattern on the opposite side of the central line m. This arrangement is shown in FIG. 10a. In this embodiment, the plurality of first openings 6 may be provided in the top part of the first surface 2 while the plurality of second openings 7 may be provided in the bottom part of the second surface 3.

In one or more embodiments, the plurality of first openings 6 may be provided on the first surface 2 in a zig zag pattern extending from the top to the bottom of the first surface 2. Similarly, the plurality of second openings 7 may be provided on the second surface 3 in a zig zag pattern extending from the top to the bottom of the second surface 3. The arrangement for the plurality of first openings 6 is shown in FIG. 10b.

The arrangement of the first openings 6 and/or the second openings 7 in a zig zag pattern enables that the number of respective first openings 6 and second openings 7 is increased and the structural stability of the heat exchange element 1 is maintained.

There is shown in FIG. 11a and 11b the fluid distribution member 8 in one embodiment of the present invention. In this embodiment of the present invention the fluid distribution member 8 is comprised of two pieces and hence is a two-piece element. Each of the inlet port 9 and the outlet port 10 is mounted on a different piece of the fluid distribution member 8. In this embodiment of the present invention, the fluid distribution member 8 may not be mounted by sliding as elaborated above, but each piece may be mounted on the respective one of the first surface 2 and second surface 3. The mounted pieces may then be connected with each other and/or with the heat exchange element 1.

In the embodiment shown in FIG. 11a each of the first piece and second piece are fixed on the heat exchange element 1 (in the figure the dashed circle is showing the position where the one piece is fixed to the heat exchange element 1). In the embodiment shown in FIG. 11b each of the first piece and second piece are fixed to each other on the upper side of the heat exchange clement 1 and lower side of the heat exchange element 1 (in the figure the dashed circles are showing the position where the pieces are fixed to each other).

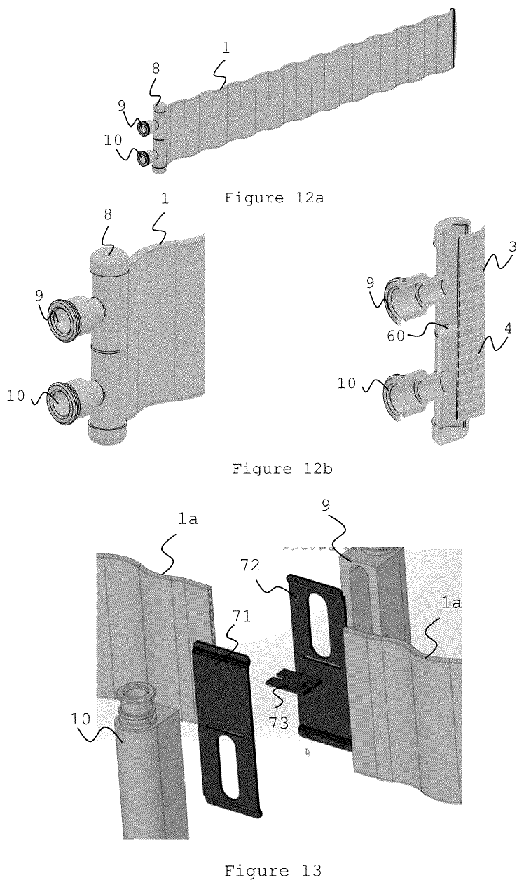

There is shown in FIG. 12a an embodiment of the present invention in which the fluid distribution member 8 is provided on one end side of the heat exchange element 1. In this embodiment of the present invention, the heat exchange element 1 may be a one-piece extruded clement as elaborated above. The fluid distribution member 8 may be provided on one end side of the heat exchange element 1 and one end member 15 may be provided at the opposite side of the heat exchange element 1. In this embodiment, the fluid makes a U-turn only at the end side where the end member 15 is provided.

In this embodiment of the present invention, a divider 60 for dividing the at least one first channel 4 and the at least one second channel 5 may be provided in the fluid distribution member 8. There is shown in FIG. 12b in the left panel a part of the heat exchange assembly 100 with the fluid distribution member 8 and in the right panel a cross sectional view of the part shown in the left panel.

In a further embodiment of the present invention, the heat exchange element 1 may be a two-piece extruded element. The fluid distribution member 8 may also be a two-piece element. There is shown in FIG. 13 an exploded view of the heat exchange element 1, the fluid distribution member 8, and elements 71, 72, 73 for mounting the fluid distribution member 8. The mounting element 73 may also have a function of separating the fluid to flow in the at least one first channel 4 from the fluid to flow in the at least one second channel 5 to exit via the outlet port 10. Each of the elements 71 and 73 may have a corresponding opening for allowing the fluid to enter the at least one first opening 6 (not shown in the figure) and to exit via the at least one second opening 7 (not shown in the figure).

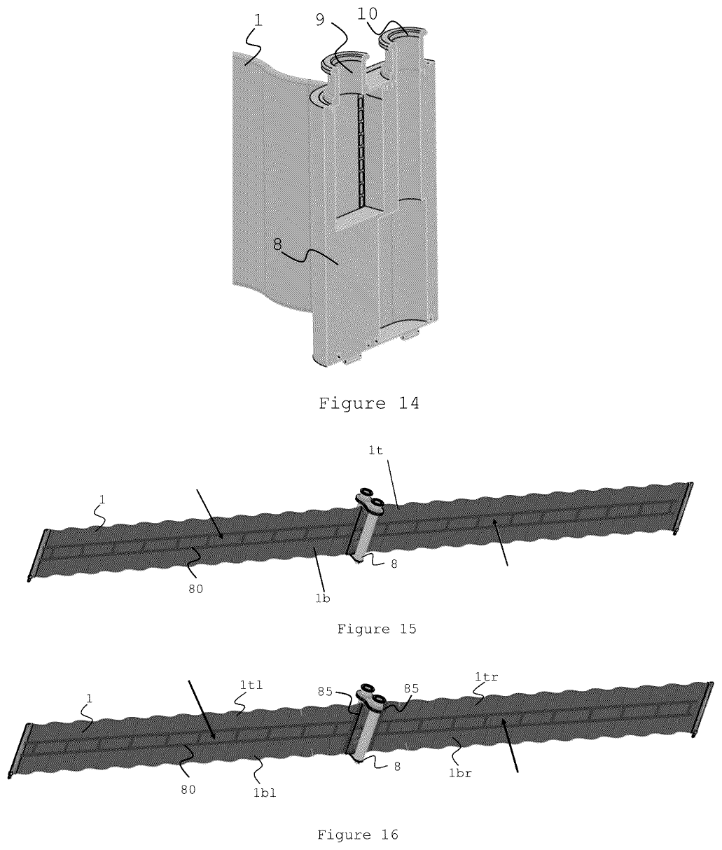

In a further embodiment of the present invention shown in FIG. 14 the heat exchange element 1 may be a two-piece element formed by extrusion and the fluid distribution member 8 may be a one-piece clement. A cross-sectional view of the fluid distribution member 8 in this embodiment is shown in FIG. 14.

In one embodiment of the present invention shown in FIG. 15 the heat exchange element 1 may be a two-piece element formed by extrusion. In this embodiment, a separator 80 may be provided in the heat exchange element 1 that divides the heat exchange element 1 to a top half It and a bottom half 1b. The separator 80 separates the top half 1t and bottom half 1b such that in part of the heat exchange element (denoted with arrows in FIG. 15) no fluid is allowed to flow. The connection between the flow of fluid in the top half 1t and in the bottom half 1b is achieved at the end sides by way of the end elements elaborated above. In this embodiment, the fluid distribution member 8 may be the one elaborated with reference to FIGS. 4 and 5.

In one embodiment of the present invention shown in FIG. 16 the heat exchange element 1 may be a four-piece component. A separator 80 is provided as in the embodiment described with reference to FIG. 15. The separator 80 separates the top half and bottom half such that in part of the heat exchange element (denoted with arrows in FIG. 16) no fluid is allowed to flow. In addition, a connection 85 in the middle portion is provided. The heat exchange element 1 is therefore divided on a top left part 1tl, top right part 1tr, bottom left part 1bl and bottom right part 1br. The four-piece construction of the heat exchange element 1 gives more flexibility in designing the fluid distribution member 8 in the middle section where the four pieces are connected to each other. The connection between the flow of fluid in the top half and in the lower half is achieved at the end sides by way of the end elements elaborated above. In this embodiment, the fluid distribution member 8 may be the one elaborated with reference to FIGS. 4 and 5.

In embodiments of the present invention at least the following combinations are possible. The fluid distribution member 8 may be provided in the middle portion of the heat exchange element 1, or at one end side or at both end sides. It may be a one-piece preformed element or may be a two-piece element.

The heat exchange element 1 may be formed by extrusion and may be a one-piece element, or a two-piece element or a four-piece element.

The heat exchange element 1 may be provided with a separator which may be in the middle portion separating along the y direction in a left half and right half or along the x direction in top and bottom half. The first end element 15 and/or the second end element 16 may have any of the forms shown in FIGS. 9 a), 9 b) and 9 c).

In summary, the present invention provides for a heat exchange assembly 100 that provides for a more uniform distribution of the temperature of the heat exchange fluid and therefore for better thermal performance.

Although detailed embodiments have been described, these only serve to provide a better understanding of the invention defined by the appended claims and are not to be seen as limiting.

1. A heat exchange assembly for a battery system, the battery system comprising a plurality of battery cells, the heat exchange assembly comprising:
a heat exchange element extending along a first direction and including:
a first surface and a second surface facing the first surface along a second direction perpendicular to the first direction;
at least one first channel and at least one second channel each for accommodating a fluid and provided between the first surface and the second surface, each of the at least one first channel and the at least one second channel extending along the first direction; and
at least one first opening provided on the first surface, the at least one first opening being in a fluid communication with the at least one first channel, and at least one second opening provided on the second surface, the at least one second opening being in a fluid communication with the at least one second channel;
wherein the heat exchange assembly further comprises a fluid distribution member mounted on the heat exchange element, the fluid distribution member comprising an inlet port for distributing the fluid in the at least one first channel via the at least one first opening and an outlet port for distributing the fluid out of the at least one second channel via the at least one second opening;
wherein the fluid distribution member is mounted on the heat exchange element in a middle portion of the heat exchange element, wherein the inlet port is arranged to face the first surface and the outlet port is arranged to face the second surface.

2. The heat exchange assembly according to claim 1, wherein the heat exchange element is a one-piece extruded element.

3. The heat exchange assembly according to claim 1, wherein the at least one first channel and the at least one second channel are arranged along a third direction that is perpendicular to each one of the first direction and the second direction.

4. The heat exchange assembly according to claim 3, wherein the at least one first opening and the at least one second opening are provided on the first surface and the second surface respectively in the middle portion of the heat exchange element.

5. The heat exchange assembly according to claim 4, wherein the at least one first opening and the at least one second opening are arranged along a central line of the middle portion or are arranged on opposite sides of the central line, said central line extending along the third direction and dividing the middle portion into two sub-portions.

6. The heat exchange assembly according to claim 1, wherein a shape of the at least one first opening is different than a shape of the at least one second opening and/or a size of the at least one first opening is different than a size of the at least one second opening.

7. The heat exchange assembly according to claim 3, wherein the fluid distribution member is a pre-formed one-piece element arranged to be mounted on the heat exchange element by sliding along the third direction.

8. The heat exchange assembly according to claim 1, further comprising a first support element and/or a second support element each mounted on the fluid distribution member, each of the first support element and/or the second support element comprising an inlet opening for accommodating the inlet port and an outlet opening for accommodating the outlet port of the fluid distribution member.

9. The heat exchange assembly according to claim 1, wherein the inlet port comprises at least one inlet opening arranged to be in fluid communication with the at least one first opening and the outlet port comprises at least one outlet opening arranged to be in a fluid communication with the at least one second opening.

10. The heat exchange assembly according to claim 1, wherein in the middle portion of the heat exchange element the first surface has a first bulge extending outwards from the heat exchange element and the second surface has a first bulge extending outwards from the heat exchange element, wherein the first bulge of the first surface forms an inlet chamber around the at least one first opening and the first bulge of the second surface forms an outlet chamber around the at least one second opening.

11. The heat exchange assembly according to claim 1, wherein in the middle portion of the heat exchange element the first surface has a second bulge extending outwards from the heat exchange element and the second surface has a second bulge extending outwards from the heat exchange element, wherein a wall of the inlet port abuts against at least a part of the second bulge of the first surface and a wall of the outlet port abuts against at least a part of the second bulge of the second surface.

12. The heat exchange assembly according to claim 1, wherein each one of the first surface and the second surface has undulations, wherein each undulation is arranged to accommodate at least one battery cell, wherein the undulations are provided in portions of the heat exchange element other than the middle portion.

13. The heat exchange assembly according to claim 1, comprising further a first end member arranged on one end of the heat exchange element and a second end member arranged on another end of the heat exchange element, each of the first end member and second end member establishing a fluid communication between the at least one first channel and the at least one second channel, wherein each of the first end member and the second end member has a curved shape for guiding the fluid between the at least one first channel and the at least one second channel.

14. The heat exchange assembly according to claim 3, wherein in the heat exchange element a plurality of first channels are provided along the third direction and/or a plurality of second channels are provided along the third direction, wherein a total number of the plurality of first channels and/or the plurality of second channels is a multiple of 2.

15. The heat exchange assembly according to claim 14, wherein a plurality of first openings are provided on the first surface, wherein each of the plurality of first openings is in a fluid communication with one of the plurality of first channels and/or a plurality of second openings are provided on the second surface, wherein each of the plurality of second openings is in a fluid communication with one of the plurality of second channels.

16. The heat exchange assembly according to claim 14, wherein a plurality of first openings are provided on the first surface, wherein each one of the plurality of first openings is in a fluid communication with a group of the plurality of first channels, and/or a plurality of second openings are provided on the second surface, wherein each one of the plurality of second openings is in a fluid communication with a group of the plurality of second channels.

17. The heat exchange assembly according to claim 16, wherein a plurality of secondary first channels are provided in the heat exchange element, each one of the plurality of secondary first channels establishing a fluid communication between one first opening and a corresponding group of the plurality of first channels, and a plurality of secondary second channels are provided in the heat exchange element, each one of the plurality of secondary second channels establishing a fluid communication between one second opening and a corresponding group of second channels.

18. The heat exchange assembly according to claim 15, wherein the plurality of first openings and the plurality of second openings are arranged along a central line or are arranged on opposite sides of the central line, wherein the plurality of first openings are arranged in a zig zag pattern on one side of the central line and the plurality of second openings are arranged in a zig zag pattern on the opposite side of the central line.

19. The heat exchange assembly according to claim 17, wherein the plurality of first openings and the plurality of second openings are arranged along a central line or are arranged on opposite sides of the central line, wherein the plurality of first openings are arranged in a zig zag pattern on one side of the central line and the plurality of second openings are arranged in a zig zag pattern on the opposite side of the central line.
